(19) United States
(12) Patent Application Publication
(10) Pub. No.: US 2026/0222083 A1
(43) Pub. Date: Jul. 30, 2026

(54) COMPUTING SYSTEM

(71) Applicant: SHANGHAI XIZHI TECHNOLOGY CO., LTD., Shanghai (CN)

(72) Inventors: Huaiyu MENG, Shanghai (CN); Yichen Shen, Shanghai (CN); Wenqing Lv, Shanghai (CN); Yelong Xu, Shanghai (CN); Shanshan Yu, Shanghai (CN); Zhang Chen, Shanghai (CN)

(21) Appl. No.: 19/634,251

(22) Filed: Mar. 31, 2026

Related U.S. Application Data
(63) Continuation of application No. PCT/CN2025/095953, filed on May 20, 2025.

(30) Foreign Application Priority Data
May 28, 2024 (CN) 202410678356.4
Jun. 29, 2024 (CN) 202410867930.0

(51) Int. Cl. H04B 10/80; H04B 10/03; H04B 10/27; H04L 41/0659

(52) U.S. Cl. CPC H04B 10/802; H04B 10/03; H04B 10/27; H04L 41/0659

(57) ABSTRACT

A computing system comprises a plurality of computing devices. Each computing device includes a plurality of computing modules and a plurality of optical interconnect expansion cards, and each optical interconnect expansion card includes an on-chip optical switch and at least one first optical switching unit. The optical interconnect expansion cards of different computing devices are communicatively connected via optical fibers. At least one computing device is configured as a backup device and remaining computing devices are configured as working devices. In response to a malfunction of one or more working devices, a connection topology of the computing devices is reconfigured by controlling the first optical switching units and/or the on-chip optical switches such that the backup devices equal in number to the malfunctioning working devices are switched to operate as working devices.

### CROSS-REFERENCE TO RELATED APPLICATION(S)

This application claims priority and benefits from Chinese Invention Patent Application No. 2024106783564, entitled “Chip, Module, Device and System for Optical Interconnection”, filed on May 28, 2024, and Chinese Invention Patent Application No. 2024108679300, entitled “Computing System”, filed on Jun. 29, 2024, the entire contents of each of which are incorporated herein by reference.

### FIELD OF THE INVENTION

The present disclosure relates generally to computing systems.

### BACKGROUND OF THE INVENTION

Computational demands for artificial intelligence (AI) models have increased at a rate that exceeds improvements in standalone computing hardware performance. As AI accelerators continue to improve through semiconductor process advancements and architectural innovations, interconnection bandwidth between AI accelerators becomes increasingly important. Interconnection networks have become a significant factor affecting overall system computational capability.

Industry initiatives, such as the Open Compute Project (OCP), have introduced standardized accelerator module form factors, including the OCP Accelerator Module (OAM), which have been adopted by leading graphics processing unit (GPU) suppliers. In some existing implementations, eight computing modules are mounted on a Universal Base Board (UBB) and interconnected through point-to-point printed circuit board (PCB) traces. Because relatively long PCB traces are required, the computing modules typically employ long-reach serializer/deserializer (SerDes) interfaces, such as CEI Long Range (LR) interfaces. In full-mesh configurations, each SerDes interface is dedicated to a specific peer computing module, which can limit the effective bandwidth available between individual pairs of computing modules.

As model parameter counts increase, conventional single-node configurations (for example, eight computing modules within a single server) may be insufficient to meet performance requirements. Larger supernodes, such as configurations including 32 or 64 computing modules interconnected via remote direct memory access over converged Ethernet (RoCE) networks, are sometimes deployed. However, such network-based interconnections may introduce communication latency associated with bandwidth constraints, thereby reducing the model FLOPs utilization (MFU) of the computing modules.

In addition, in certain existing supernode deployments, when a computing module fails during a training process, an entire supernode is removed from service and replaced with a standby supernode while the failed module is repaired offline. Because the standby resource is provisioned at a supernode granularity, deployment cost increases. As supernode scale increases, for example in a supernode including 32 computing modules, failure of a single computing module may require replacement of all 32 computing modules, significantly increasing standby resource requirements.

### SUMMARY OF THE INVENTION

In accordance with some embodiments, a computing system is provided in which reconfigurable optical interconnection is implemented through optical interconnect expansion cards to increase bandwidth and reduce latency. By controlling on-chip optical switches and first optical switching units to change a connection topology in real time, a backup computing device may replace a malfunctioning computing device or a malfunctioning computing module therein, thereby avoiding replacement of all computing modules within a supernode.

In some embodiments, the computing system comprises a plurality of computing devices. Each computing device includes a plurality of computing modules and a plurality of optical interconnect expansion cards. Each optical interconnect expansion card includes an on-chip optical switch and at least one first optical switching unit. The optical interconnect expansion cards of different computing devices are communicatively connected via optical fibers.

At least one computing device is configured as a backup device and the remaining computing devices are configured as working devices. When one or more working devices malfunction, a connection topology of the computing devices is reconfigured by controlling the first optical switching units and/or the on-chip optical switches such that the backup devices equal in number to the malfunctioning working devices are switched to operate as working devices.

In some embodiments, the plurality of computing devices includes N computing devices, wherein N is an integer greater than 1, and the computing devices are logically ordered from 1 to N. For each computing device M, where 1<M<N, a first portion of the optical interconnect expansion cards of computing device M is connected via optical fibers to a portion of the optical interconnect expansion cards of computing device M−1, and a second portion is connected via optical fibers to a portion of the optical interconnect expansion cards of computing device M+1.

A first portion of the optical interconnect expansion cards of computing device N is connected via optical fibers to a portion of the optical interconnect expansion cards of computing device N−1, and a second portion of the optical interconnect expansion cards of computing device N is connected via optical fibers to a portion of the optical interconnect expansion cards of computing device 1.

A first portion of the optical interconnect expansion cards of computing device 1 is connected via optical fibers to a portion of the optical interconnect expansion cards of computing device N, and a second portion of the optical interconnect expansion cards of computing device 1 is connected via optical fibers to a portion of the optical interconnect expansion cards of computing device 2.

In some embodiments, the first portion and the second portion are equal in number, each comprising half of the optical interconnect expansion cards of the respective computing device.

In some embodiments, by controlling the first optical switching units and/or the on-chip optical switches, computing modules in computing devices 1 to K form a supernode having a predetermined topology, where K<N.

In response to a malfunction of computing device J among computing devices 1 through K, the connection topology is reconfigured such that a backup device joins the topology and becomes a working device, and computing modules in consecutive computing devices other than computing device J form a new supernode. In some embodiments, after computing device J is repaired, the connection topology is further reconfigured such that computing device J is configured as a backup device.

In some embodiments, controlling the first optical switching units and/or the on-chip optical switches includes: controlling the first optical switching unit to selectively transmit a signal from a computing module to the on-chip optical switch or to an optical fiber; and controlling the on-chip optical switch to select a transmission path for communication among the plurality of computing modules within the same computing device.

In some embodiments, by controlling the first optical switching units and/or the on-chip optical switches, computing modules in computing devices 1 to N−1 are configured to form a one-dimensional ring topology, and computing device N serves as a backup device.

In response to a malfunction of computing device M among computing devices 1 through N−1, the connection topology is reconfigured such that computing device N joins the topology and becomes a working device, and computing modules in computing devices 1 to M−1 and M+1 to N form a reconfigured one-dimensional ring topology. In some embodiments, after computing device M is repaired, the connection topology is further reconfigured such that computing device M is configured as a backup device.

In some embodiments, the connection topology is reconfigured by controlling the first optical switching units and the on-chip optical switches of computing devices M−1, M, and M+1 to disconnect optical fibers between computing device M and computing device M−1 and between computing device M and computing device M+1, and to adjust internal communication paths for computing modules in computing devices M−1 and M+1; and controlling the first optical switching units and the on-chip optical switches of computing devices 1 and N to establish optical fiber communication therebetween and adjust corresponding internal communication paths for computing modules.

In some embodiments, the connection topology of the plurality of computing devices is reconfigured by controlling the on-chip optical switches and/or the at least one first optical switching unit, such that a subset of the plurality of computing devices operates as working devices and forms a plurality of independent supernodes, and the remaining computing devices operate as backup devices. The plurality of independent supernodes comprise one or more first supernodes and one or more second supernodes. Each first supernode comprises one or more computing devices, and each second supernode comprises one or more computing devices. A topology of the first supernodes differs from a topology of the second supernodes.

In some embodiments, in response to a malfunction of any computing device operating as a working device, the connection topology is reconfigured by controlling the on-chip optical switches and/or the at least one first optical switching unit, such that: the malfunctioning computing device is communicatively isolated; the backup devices equal in number to the malfunctioning computing devices are activated as working devices; and consecutive working devices are reorganized to form the first supernodes and the second supernodes.

In some embodiments, the plurality of independent supernodes further comprise one or more third supernodes, wherein each third supernode comprises one or more computing devices, and a topology of the third supernodes differs from the topologies of the first supernodes and the second supernodes.

In some embodiments, in response to a malfunction of any computing device operating as a working device, the connection topology is reconfigured by controlling the on-chip optical switches and/or the at least one first optical switching unit, such that: the malfunctioning computing device is communicatively isolated; the backup devices equal in number to the malfunctioning computing devices are activated as working devices; and consecutive working devices are reorganized to form the first supernodes, the second supernodes, and the third supernodes.

In some embodiments, a computing system is provided. The computing system comprises a plurality of computing devices, each computing device comprising a plurality of computing modules and a plurality of optical interconnect expansion cards. Wherein each optical interconnect expansion card comprises an on-chip optical switch and at least one first optical switching unit, and the optical interconnect expansion cards of the plurality of computing devices are communicatively connected via optical fibers. Wherein at least a portion of the computing modules of at least one computing device are configured as backup modules and the remaining computing modules are configured as working modules. In response to a malfunction of one or more working modules, a connection topology of the computing modules is reconfigured by controlling the at least one first optical switching unit and/or the on-chip optical switches such that the backup modules equal in number to the malfunctioning working modules are switched to operate as working modules.

In some embodiments, the plurality of computing devices comprises N computing devices, N being an integer greater than 1.The computing devices are logically ordered from 1 to N, wherein for each computing device M, where 1<M<N, a first portion of the optical interconnect expansion cards of computing device M is connected via optical fibers to a portion of the optical interconnect expansion cards of computing device M−1, and a second portion of the optical interconnect expansion cards of computing device M is connected via optical fibers to a portion of the optical interconnect expansion cards of computing device M+1. A first portion of the optical interconnect expansion cards of computing device N is connected via optical fibers to a portion of the optical interconnect expansion cards of computing device N−1, and a second portion of the optical interconnect expansion cards of computing device N is connected via optical fibers to a portion of the optical interconnect expansion cards of computing device 1. A first portion of the optical interconnect expansion cards of computing device 1 is connected via optical fibers to a portion of the optical interconnect expansion cards of computing device N, and a second portion of the optical interconnect expansion cards of computing device 1 is connected via optical fibers to a portion of the optical interconnect expansion cards of computing device 2.

In some embodiments, the first portion and the second portion are equal in number, each comprising half of the optical interconnect expansion cards of the respective computing device.

In some embodiments, the connection topology of the computing modules is reconfigured by controlling the on-chip optical switches and/or the at least one first optical switching unit, such that a subset of the computing modules operates as working modules and forms one or more independent supernodes, and the remaining computing modules operate as backup modules. The one or more independent supernodes comprise one or more first supernodes. Each first supernode comprises consecutive computing modules. The computing modules within each first supernode form a first target topology by controlling the on-chip optical switches and/or the at least one first optical switching unit.

In some embodiments, the one or more independent supernodes further comprise one or more second supernodes. Each second supernode comprises consecutive computing modules. The computing modules within each second supernode form a second target topology by controlling the on-chip optical switches and/or the at least one first optical switching unit. The first target topology differs from the second target topology.

In some embodiments, the plurality of independent supernodes further comprise one or more third supernodes, wherein each third supernode comprises consecutive computing modules. The computing modules within each third supernode form a third target topology by controlling the on-chip optical switches and/or the at least one first optical switching unit. The third target topology differs from the first target topology and the second target topology. Optionally, the first target topology, the second target topology, and the third target topology each comprise a one-dimensional ring topology having different numbers of computing modules.

In some embodiments, in response to a malfunction of any working module, the connection topology is reconfigured by controlling the on-chip optical switches and/or the at least one first optical switching unit, such that: the malfunctioning working module is communicatively isolated; the backup modules equal in number to the malfunctioning working modules are activated as working modules; and consecutive working modules are reorganized to form a new plurality of supernodes having the same respective topologies as those existing prior to the malfunction.

In some embodiments, the backup modules are distributed at any position adjacent to the one or more supernodes.

According to embodiments, reconfigurable optical interconnection is implemented through the optical interconnect expansion cards to increase system bandwidth and reduce latency. By controlling the on-chip optical switches and/or the first optical switching units, the connection topology may be reconfigured in real time to form different supernodes, thereby enabling flexible configuration to satisfy different computational requirements.

For example, through control of the on-chip optical switches and/or the first optical switching units, vertical supernodes may be flexibly combined or partitioned. Millisecond-level topology switching may be achieved, supporting supernodes including, but not limited to, configurations comprising 16 computing modules (e.g., TP16), 32 computing modules (TP32), 64 computing modules (TP64), and 128 computing modules (TP128).

By connecting a plurality of computing devices through reconfigurable optical interconnect expansion cards and direct optical fiber interconnections, the use of external electrical switches and external optical switches may be avoided, thereby reducing interconnection cost.

In accordance with some embodiments, redundancy granularity may be at a computing-device level, where each computing device includes a plurality of computing modules. By reconfiguring the connection topology through the optical interconnect expansion cards, a malfunctioning computing device may be removed or communicatively isolated, and any number of consecutive computing devices may form a new supernode without interrupting operation of the overall system.

Redundancy granularity may alternatively be at a computing-module level. Through reconfiguration of the optical interconnect expansion cards, a malfunctioning computing module may be bypassed or communicatively isolated, and one or more backup modules may be activated to form a new supernode. This configuration may reduce deployment cost of computing modules. Compared with replacing an entire supernode, millisecond-level topology reset time may be achieved, resulting in reduced latency and improved cluster operational efficiency.

Furthermore, the optical interconnection structure described herein overcomes interconnection distance limitations associated with printed circuit board traces. Through long-distance optical fiber connections, existing multi-card computing systems may be decoupled, such that computational capacity scaling of nodes (i.e., computing devices) is no longer constrained by hierarchical interconnection structures. Bandwidth distribution within a node and between nodes may be more uniform, facilitating large-scale expansion of computing modules.

Using the optical interconnection structure described herein, interconnection among computing modules is not fixed, but instead is field-reconfigurable. This enables topology modification according to requirements of a particular artificial intelligence model.

From a topology perspective, data flow requirements of artificial intelligence models may generally be categorized into three types: Data parallelism, in which each computing module loads an entire model and different computing modules process different portions of a dataset; Model parallelism, in which certain layers of a model are sufficiently large that each computing module performs only a portion of computations associated with such layers; and Pipeline parallelism, in which different layers of a model are assigned to different computing modules for computation and different data flow patterns correspond to different interconnection topologies among computing modules. By using reconfigurable optical interconnection, different interconnection topologies among computing modules may be rapidly switched, thereby improving bandwidth utilization and enhancing scalability of artificial intelligence computing systems, enabling a plurality of computing modules to cooperate efficiently and reliably to accelerate large-scale models

Various aspects, features, and advantages of embodiments of the present invention will be described below with reference to the accompanying drawings.

### BRIEF DESCRIPTION OF THE DRAWINGS

FIG. 1 is a schematic cross-sectional view illustrating an example structure of an optical interconnection module according to an embodiment of the present invention.

FIG. 2A is a schematic diagram illustrating an example of a photonic circuit structure formed on a photonic integrated circuit chip in the optical interconnection module shown in FIG. 1;

FIG. 2B is a schematic diagram illustrating another example of a photonic circuit structure formed on a photonic integrated circuit chip in the optical interconnection module shown in FIG. 1.

FIG. 3 is a schematic diagram illustrating a photonic circuit structure of an on-chip optical switch in the photonic integrated circuit chip shown in FIGS. 2A and 2B.

FIG. 4 is a schematic diagram illustrating an example structure of a first optical switching unit on the photonic integrated circuit chip shown in FIGS. 2A and 2B.

FIG. 5 is a schematic diagram illustrating an example structure of a second optical switching unit in the on-chip optical switch shown in FIG. 3.

FIG. 6 is a schematic diagram illustrating a planar layout of a reconfigurable optical interconnection expansion card according to an embodiment of the present invention.

FIG. 7 is a schematic diagram illustrating a packaging structure of the reconfigurable optical interconnection expansion card shown in FIG. 6.

FIG. 8 is a schematic diagram illustrating an example structure of a computing device according to an embodiment of the present invention.

FIGS. 9A to 9D are schematic diagrams respectively illustrating reconfigurable topological structures among computing modules in a computing device according to embodiments of the present invention.

FIG. 10 is a schematic diagram illustrating an example structure of a computing system according to another embodiment of the present invention.

FIG. 11 is a schematic diagram illustrating changes in connection topology of a computing system according to an embodiment of the present invention.

FIG. 12 is a schematic diagram illustrating changes in connection topology of a computing system having redundancy at a computing-device level according to an embodiment of the present invention.

FIG. 13 is a schematic diagram illustrating changes in connection topology of a computing system having redundancy at a computing-module level according to an embodiment of the present invention.

### DETAILED DESCRIPTION OF THE INVENTION

The exemplary embodiments will be described below in greater detail with reference to the accompanying drawings. Certain terminology may be used in the following description for the purpose of reference only, and thus are not intended to be limiting. For example, terms such as “top”, “bottom”, “upper”, “lower”, “above”, and “below” could be used to refer to directions in the drawings to which reference is made. Terms such as “front”, “back”, “rear”, “side”, “outboard”, and “inboard” could be used to describe the orientation and/or location of portions of the component within a consistent but arbitrary frame of reference which is made clear by reference to the text and the associated drawings describing the component under discussion. Similarly, the terms “first”, “second”, and other such numerical terms referring to structures do not imply a sequence or order unless clearly indicated by the context.

It will be understood that when an element or feature is referred to as being “on,” “connected to,” or “coupled to” another element or layer, it can be directly on, connected to, or coupled to the other element or feature, or one or more intervening elements or features may be present. In addition, it will also be understood that when an element or features is referred to as being “between” two elements or features, it can be the only element or feature between the two elements or features, or one or more intervening elements or features may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

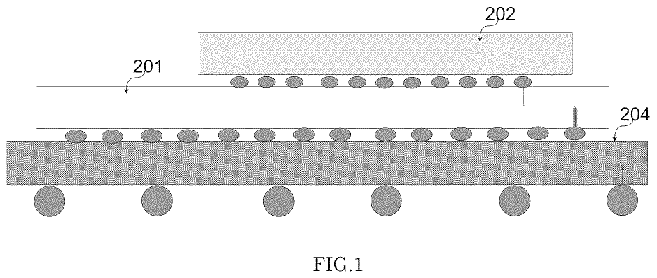

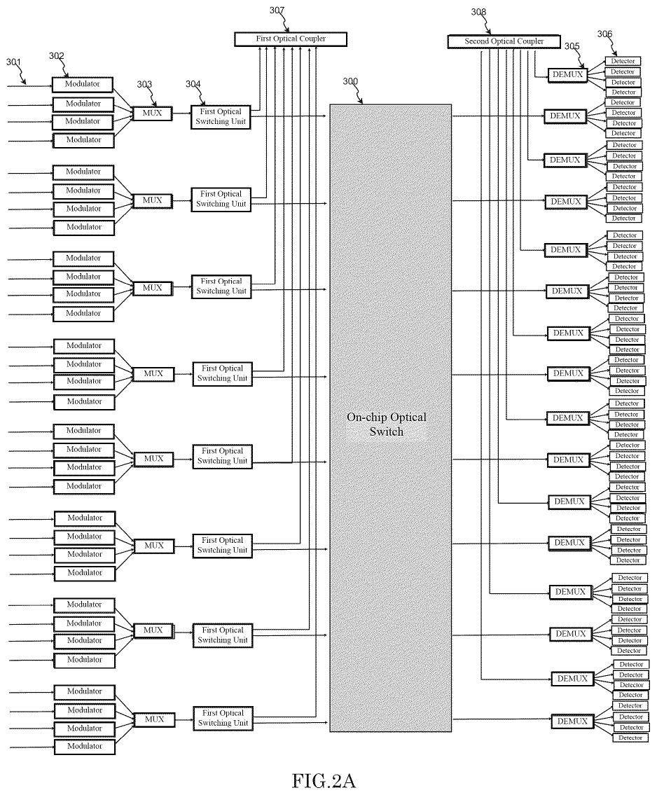

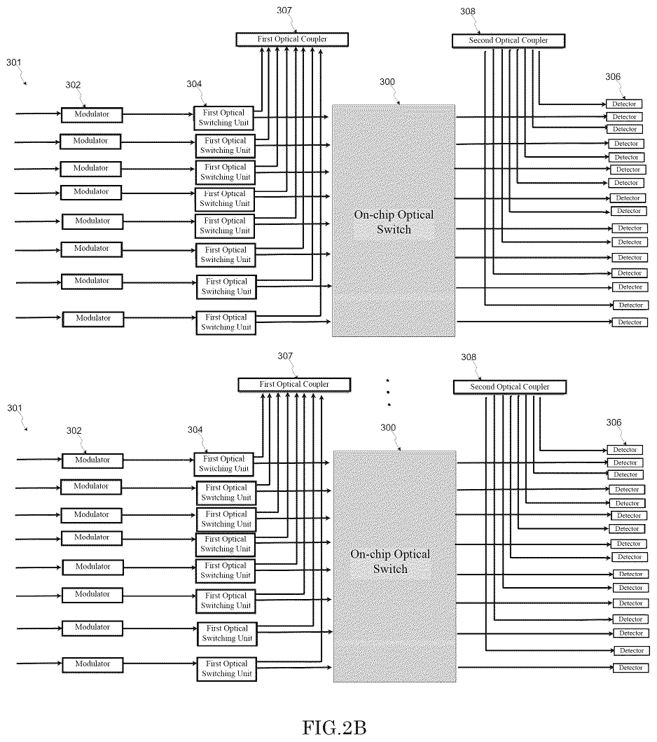

Referring to FIGS. 1-5, exemplary embodiments of an optical interconnection module are described. In some embodiments, the optical interconnection module includes a photonic integrated circuit (PIC) chip 201 and a transceiver analog electrical chip 202. As shown in FIG. 1, the PIC chip 201 is disposed on a substrate 204, and the transceiver analog electrical chip 202 is disposed on the PIC chip 201. As shown in FIG. 2A, the PIC chip 201 includes one or more PIC sub-modules. Each PIC sub-module includes a plurality of modulators 302, a plurality of wavelength multiplexers 303, a plurality of first optical switching units 304, at least one on-chip optical switch 300, a plurality of demultiplexers 305, a plurality of detectors 306, a first optical coupler 307, and a second optical coupler 308.

In an exemplary embodiment, a group of modulators 302 (which may be configured as a modulator array) is optically connected to one first optical switching unit 304 via one wavelength multiplexer 303. The wavelength multiplexer 303 includes a plurality of optical input ports and one optical output port. Each optical input port is connected to a respective modulator 302, and the optical output port is connected to the first optical switching unit 304.

Each first optical switching unit 304 is optically connected to a group of modulators 302 via a wavelength multiplexer 303. Each first optical switching unit 304 includes a first optical input port, a first optical output port, and a second optical output port. The first optical input port is connected to the optical output port of the wavelength multiplexer 303. The first optical output port is connected to the first optical coupler 307. The first optical coupler 307 optically connects the first optical output ports of the plurality of first optical switching units 304 to an external optical fiber. The second optical output port is connected to the on-chip optical switch 300. Each first optical switching unit 304 is configured to selectively output an optical signal received at the first optical input port via either the first optical output port or the second optical output port.

The on-chip optical switch 300 includes a plurality of optical input ports and a plurality of optical output ports. The optical input ports are respectively connected to the second optical output ports of the plurality of first optical switching units 304. The on-chip optical switch 300 is configured to selectively output an optical signal received at any one of the optical input ports via at least one of the optical output ports, thereby changing an output path of the optical signal and correspondingly changing a topology of an optical transmission network. The optical output ports of the on-chip optical switch 300 are respectively connected to a plurality of demultiplexers 305. Each demultiplexer 305 is connected to a group of detectors 306 (which may be configured as a detector array). Each demultiplexer 305 includes one optical input port and a plurality of optical output ports. The optical input port is connected to one optical output port of the on-chip optical switch 300, and each optical output port of the demultiplexer 305 is connected to a respective detector 306.

In an exemplary embodiment, each modulator array modulates light waves of different wavelengths. Each modulator 302 modulates input light 301 according to a driving analog electrical signal received from the transceiver analog electrical chip 202, thereby loading information carried by the electrical signal onto the input light to generate an optical signal carrying information. The wavelength multiplexer 303 combines optical signals of different wavelengths into a single optical signal. The combined optical signal is selectively routed by the first optical switching unit 304 to either a first external optical fiber array (not shown) via the first optical coupler 307, or to the on-chip optical switch 300. If routed to the on-chip optical switch 300, the optical signal is demultiplexed by the demultiplexer 305 into optical signals of different wavelengths and transmitted to corresponding detectors 306 for photoelectric conversion. If routed to the first external optical fiber array, the optical signal is transmitted through an external optical fiber to a demultiplexer and detector array on another chip. In some embodiments, the PIC chip 201 further includes a second optical coupler 308 configured to receive an optical signal from a second external optical fiber array (not shown) and transmit the optical signal to the demultiplexer 305 and associated detector array on the PIC chip 201.

In some embodiments, the transceiver analog electrical chip 202 is configured to convert a first digital electrical signal into a driving analog electrical signal and transmit the driving analog electrical signal carrying the information to at least one modulator 302 in the PIC chip 201, or to receive an analog electrical signal output by at least one detector 306 in the PIC chip 201 and convert the received analog electrical signal into a second digital electrical signal. The modulator 302 is configured to modulate the information carried by the driving analog electrical signal onto the optical signal.

In some embodiments, as shown in FIG. 1, the transceiver analog electrical chip 202 is disposed above the PIC chip 201 and communicates the first digital electrical signal and/or the second digital electrical signal through conductive vias extending through the PIC chip 201. The transceiver analog electrical chip 202 is mounted on a side of the PIC chip 201 opposite the substrate 204.

In alternative embodiments, when the input light 301 is single-wavelength light, the PIC chip 201 may be configured without wavelength multiplexers 303 and demultiplexers 305. As shown in FIG. 2B, one first optical switching unit 304 corresponds to one modulator 302 and two detectors. One detector is connected to the on-chip optical switch 300, and the other detector is connected to the first external optical fiber array via the first optical coupler 307. In some embodiments, the second optical coupler 308 may be directly connected to a detector 306 such that the detector 306 may be connected through a second external optical fiber array to a first optical switching unit of another chip.

In other embodiments, as shown in FIG. 2B, the PIC chip includes a plurality of PIC sub-modules, each having substantially the same circuit structure.

In some embodiments, the PIC chip 201 further includes a third optical coupler (not shown) and an optical power splitter (not shown). The third optical coupler is configured to receive light from an off-chip light source. The optical power splitter is optically connected to the third optical coupler and is configured to split input light into a plurality of output lights having substantially equal power, which are transmitted to respective modulators 302.

In some embodiments, the first optical switching unit 304 is a 1x2 optical switching unit. The first optical switching unit 304 may be implemented as a MEMS optical circuit switching unit or a Mach-Zehnder interferometer (MZI) optical circuit switching unit. As shown in FIG. 4, the first optical switching unit 304 may include a Mach-Zehnder interferometer structure comprising: a first beam splitter 408 having one optical input port and two optical output ports; a second beam splitter 407 having two optical input ports and two optical output ports; and two phase shifters 406 respectively connected between the two optical output ports of the first beam splitter 408 and the two optical input ports of the second beam splitter 407. The phase shifters 406 may be electro-optic or thermo-optic phase shifters. By controlling the phase shifters 406 on upper and lower arms, a phase of an optical signal may be adjusted and an output port may be selected based on interference effects.

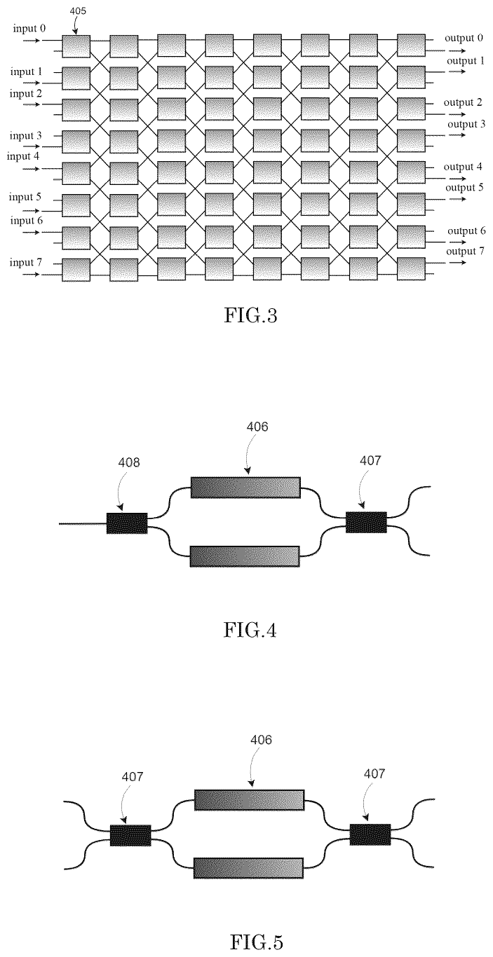

In some embodiments, as shown in FIG. 3, the on-chip optical switch 300 includes a plurality of second optical switching units 405. The optical interconnection module further includes an optical switching control analog electrical chip (not shown) configured to control the plurality of second optical switching units 405 to select a transmission path for an optical signal received at the on-chip optical switch 300, such that the optical signal is output from at least one optical output port of the on-chip optical switch. In some embodiments, the on-chip optical switch 300 is an 8×8 strictly non-blocking optical switch including sixty-four 2×2 optical switching units 405. By controlling the signal output port of each switching unit, any arbitrary combination of paths between 8 input channels and 8 output channels in FIG. 3 can be established, and insertion loss along each path is substantially independent of path selection. Thus, the topology from input ends to output ends in the system can be reconfigured. In specific applications, the 8×8 silicon optical switch can be further replicated laterally to meet larger bandwidth switching requirements. The optical switch structure in this embodiment is exemplary. Depending on actual needs, the on-chip optical switch may be implemented as any n×n non-blocking optical switch. Reconfigurable optical interconnection may change a network topology for different artificial intelligence applications to optimize data migration efficiency and improve system performance.

In some embodiments, the second optical switching unit 405 is implemented as an MZI optical circuit switching unit.

In some embodiments, as shown in FIG. 5, the second optical switching unit adopts an MZI optical circuit switching unit, which includes two beam splitters 407, each beam splitter 407 having two optical input ports and two optical output ports; and two phase shifters 406 respectively connected between the two optical output ports of one beam splitter 407 and the two optical input ports of the other beam splitter 407. It can be seen that the second optical switching unit can also adopt a Mach-Zehnder interferometer structure. By controlling the phase shifters 406, a phase of an input optical signal may be adjusted and an output port may be selected based on interference effects.

In some embodiments, the modulator 302 includes at least one of: a microring modulator, a Mach-Zehnder modulator, or an electro-absorption modulator. The detector 306 includes a microring detector or a photodiode.

In some implementations, each of the PIC sub-modules further includes a third optical switching unit (not shown). The detector or demultiplexer is optically connected to the on-chip optical switch and the second optical coupler via the third optical switching unit. The number of detectors or detector arrays is equal to the number of modulators or modulator arrays. Specifically, the third optical switching unit includes a first optical input port, a second optical input port, and an optical output port. The first optical input port of the third optical switching unit is connected to the second optical coupler. The second optical input port of the third optical switching unit is connected to one optical output port of the on-chip optical switch. The optical output port of the third optical switching unit is connected to the detector or the demultiplexer. By controlling the third optical switching unit, either the first optical input port or the second optical input port of the third optical switching unit is connected to the optical output port of the third optical switching unit.

In some implementations, the third optical switching units are respectively disposed on the optical path connecting the detector or detector array to the on-chip optical switch, and on the optical path connecting the detector or detector array to the second optical coupler.

In some implementations, the third optical switching unit is a MEMS optical circuit switching unit or an MZI optical circuit switching unit. By providing the third optical switching unit, one detector or detector array can be used at different times to receive optical signals from the on-chip optical switch and optical signals from the second optical coupler, thereby reducing the total number of detectors or detector arrays.

In conventional systems, point-to-point full interconnection between computing modules is implemented on a universal base board using PCB traces. Such PCB traces may be insufficient to meet bandwidth requirements between computing modules. By adopting the optical interconnection module described herein, bandwidth within a node and between nodes may be made more uniform, thereby facilitating large-scale expansion of computing modules. In addition, reconfigurable optical interconnection enables dynamic modification of network topology to accommodate different artificial intelligence (AI) applications, thereby improving data migration efficiency and overall computing system performance.

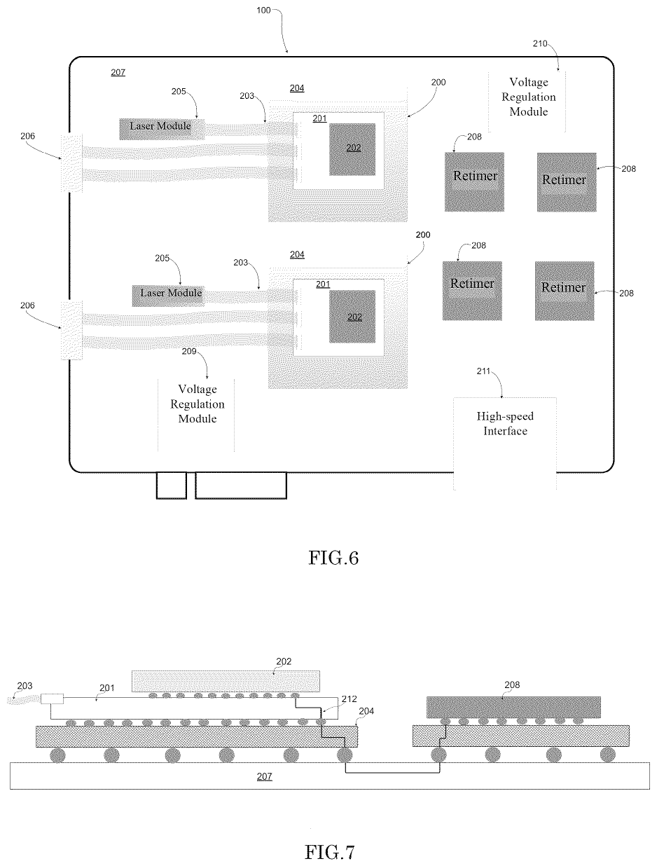

In some embodiments, the optical interconnection module is disposed on an optical interconnection expansion card to facilitate pluggable connection with a computing device. FIGS. 6 and 7 illustrate an exemplary optical interconnection expansion card 100. Because the optical interconnection module provides reconfigurable optical interconnection, the expansion card may also be referred to as a reconfigurable optical interconnection expansion card. As shown in FIGS. 6 and 7, the optical interconnection expansion card 100 includes: a printed circuit board (PCB) 207, an optical interconnection module 200, a laser module 205, an optical fiber interface 206, an electrical communication interface (illustratively a high-speed interface 211), a retimer 208, a first voltage regulation module 209 (e.g., 54V to 12V), and a second voltage regulation module 210 (e.g., 12V to a voltage rail).

The optical interconnection module 200 is disposed on the PCB 207 and may adopt the optical interconnection module described in any of the above embodiments or implementations, including the PIC chip 201, the transceiver analog electrical chip 202, and the corresponding substrate 204. The laser module 205 is disposed on the PCB 207 and optically connected to the optical interconnection module 200 via a third optical fiber array 203 to provide input light. The optical fiber interface 206 is disposed on the PCB 207 and optically connected to the optical interconnection module 200 via first and second external optical fiber arrays to enable optical communication. The high-speed interface 211 is disposed on the PCB 207 for receiving the first digital signal and/or sending the second digital electrical signal. The retimer 208 is disposed on the PCB 207 and is communicatively connected to the high-speed interface 211 and the optical interconnection module 200. The retimer 208 is configured to: reshape the first digital electrical signal before transmitting it to the optical interconnection module 200; and/or reshape a second digital electrical signal received from the optical interconnection module 200 before transmitting it via the electrical communication interface. Each retimer 208 has a plurality of communication channels, and the electrical communication interfaces have a plurality of communication channels. The total number of communication channels of the retimers 208 equals the total number of electrical channels of the electrical communication interfaces. The retimer 208 is communicatively connected to the optical interconnection module 200 via PCB traces.

An electrical signal received by the high-speed interface 211 from an information sending device, e.g., a computing module, is reshaped by the retimer 208. The reshaped signal is transmitted through traces on the package substrate and PCB 207 to the optical interconnection module 200, and further through metal traces on the substrate 204 and through-silicon vias 212 to the transceiver analog electrical chip 202. The transceiver analog electrical chip 202 and the PIC chip 201 perform signal amplification and electro-optic conversion, then the signal is transmitted via optical fibers, and optical path reconfiguration is performed in the PIC chip 201. For example, laser light generated by the laser module 205 is input into the optical interconnection module 200 is modulated in accordance with the electrical signal received from the transceiver analog electrical chip 202 via the modulator to generate an optical signal carrying information. After optical path reconfiguration by the first optical switching unit and the on-chip optical switch within the PIC chip 201, the optical signal is output to a communication peer (e.g., another computing module) via an optical fiber and the optical fiber interface 206. Conversely, an optical signal received via the optical fiber interface 206 undergoes photoelectric conversion by the detector of the optical interconnection module 200. The resulting electrical signal is transmitted to a receiving end (e.g., a computing module) via the transceiver analog electrical chip 202, the retimer 208, and the high-speed interface 211.

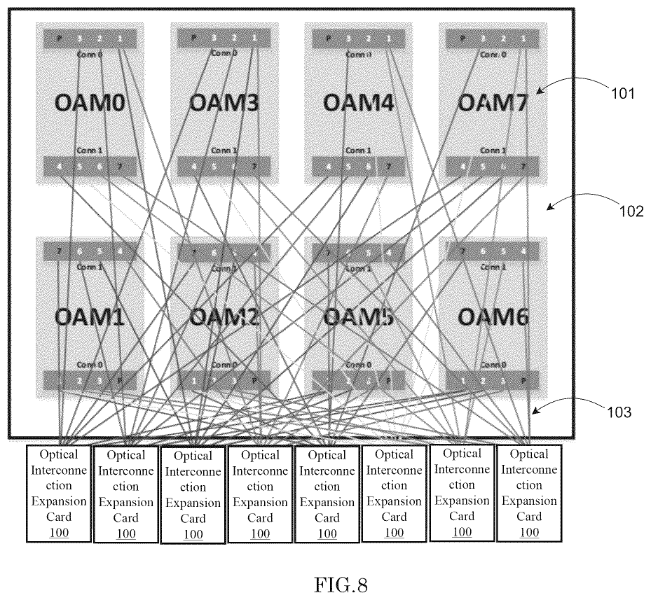

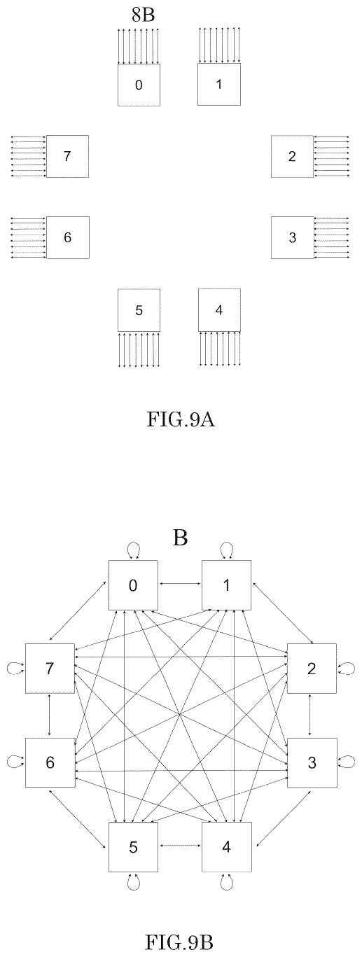

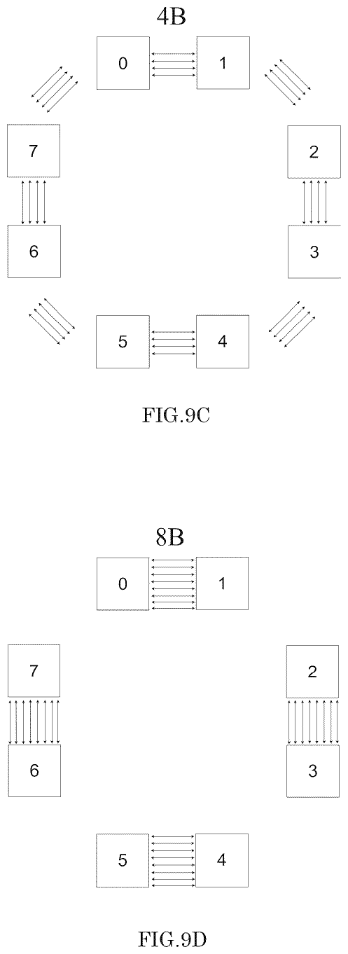

In some embodiments, a plurality of computing modules 101 are communicatively connected through a plurality of optical interconnection expansion cards 100 to form a computing device. As shown in FIG. 8, the computing device includes: a plurality of computing modules 101 (for example, eight OAM modules numbered 0, 1, 2, 3, 4, 5, 6, 7, each carrying one or more computing chips on an OAM board), a plurality of optical interconnection expansion cards 100 (e.g., 8 optical interconnection expansion cards), and a PCB 102. The PCB 102 may be a universal base board (UBB). In some embodiments, the computing modules 101 are connected to the optical interconnection expansion cards 100 via PCB traces 103 and communicate through high-speed long-reach SerDes interfaces coupled to the high-speed interfaces 211 to form an eight-card system. By controlling the first optical switching units and the on-chip optical switches within the optical interconnection expansion cards 100, the connection topology among the computing modules 101 may be reconfigured. For example, the connection topology among the computing modules 101 (numbered 0, 1, 2, 3, 4, 5, 6, 7) can be reconfigured in real-time to full external interconnection (FIG. 9A), internal full interconnection (FIG. 9B), ring topology (FIG. 9C), or point-to-point topology (FIG. 9D). Accordingly, communication bandwidth between computing module 0 and computing module 1 can be switched in real-time among bandwidth B (FIG. 9B: full interconnection), bandwidth 4B (FIG. 9C: ring), and bandwidth 8B (FIG. 9D: point-to-point), depending on the selected topology. This can match the bandwidth requirements of different communication algorithms, improve bandwidth utilization, and thus enhance the overall operational efficiency of the AI computing system.

Furthermore, in some embodiments, a plurality of computing devices are directly connected via corresponding optical interconnection expansion cards and optical fibers, without requiring external switches. Reconfigurable optical interconnection through optical interconnection expansion cards can also enhances bandwidth and reduces latency. By controlling the on-chip optical switches and optical switching units to modify connection topology in real time, different supernodes may be formed, enabling flexible configuration to meet different computing requirements.

In an exemplary embodiment, a computing system includes a plurality of computing devices. Each computing device includes a plurality of computing modules and a plurality of optical interconnection expansion cards. Each optical interconnection expansion card includes an on-chip optical switch and at least one first optical switching unit. The on-chip optical switch is configured for mutual communication among the plurality of computing modules within the same computing device. The optical interconnection expansion cards of different computing devices communicate via optical fiber connections. The first optical switching unit is configured to selectively transmit a signal from a computing module to either the on-chip optical switch or an optical fiber. In some embodiments, the optical interconnection expansion card may be the optical interconnection expansion card 100 described in any of the above embodiments or implementations, or have the structure, configuration, etc., of the optical interconnection expansion card described in any of the above embodiments or implementations, and therefore will not be repeated herein. In some implementations, the computing device may be the computing device described in any of the above embodiments or implementations, or have the structure, configuration, etc., of the computing device described in any of the above embodiments or implementations, and therefore will not be repeated herein.

In some implementations, the plurality of computing devices include a first computing device, a second computing device, and a third computing device. A first portion of the plurality of optical interconnection expansion cards of the first computing device is interconnected via optical fibers with a portion of the plurality of optical interconnection expansion cards of the second computing device. A second portion of the plurality of optical interconnection expansion cards of the first computing device is interconnected via optical fibers with a portion of the plurality of optical interconnection expansion cards of the third computing device. In some embodiments, the first portion is half of the plurality of optical interconnection expansion cards of the first computing device, and the second portion is the remaining half of the plurality of optical interconnection expansion cards of the first computing device.

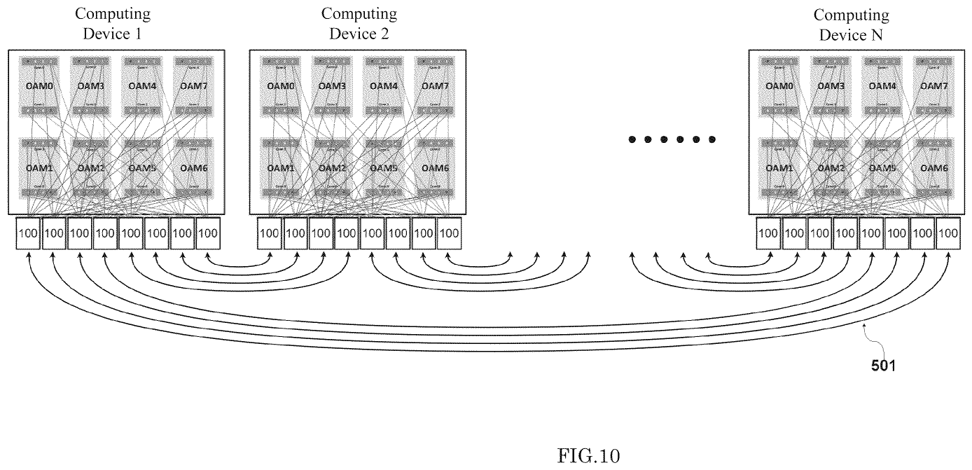

As shown in FIG. 10, in some embodiments, a computing system includes N computing devices, where N is an integer greater than 1. Each computing device includes 8 computing modules (OAMs) and 8 optical interconnection expansion cards 100. The computing modules are connected to the corresponding optical interconnection expansion cards via metal traces. It should be understood that the disclosure is not limited thereto, and each computing device may include any number of computing modules and optical interconnection expansion cards. The N computing devices are ordered from 1 to N. A first portion of the plurality of optical interconnection expansion cards 100 of computing device M is interconnected via optical fibers 501 with a portion of the plurality of optical interconnection expansion cards 100 of computing device M-−1. A second portion of the plurality of optical interconnection expansion cards 100 of computing device M is interconnected via optical fibers 501 with a portion of the plurality of optical interconnection expansion cards 100 of computing device M+1. Here, M is an integer greater than 1 and less than N. Furthermore, a first portion of the plurality of optical interconnection expansion cards 100 of computing device 1 is interconnected via optical fibers 501 with a portion of the plurality of optical interconnection expansion cards 100 of computing device N. A second portion of the plurality of optical interconnection expansion cards 100 of computing device 1 is interconnected via optical fibers 501 with a portion of the plurality of optical interconnection expansion cards 100 of computing device 2. A first portion of the plurality of optical interconnection expansion cards 100 of computing device N is interconnected via optical fibers 501 with a portion of the plurality of optical interconnection expansion cards 100 of computing device N−1. A second portion of the plurality of optical interconnection expansion cards 100 of computing device N is interconnected via optical fibers 501 with a portion of the plurality of optical interconnection expansion cards 100 of computing device 1. In some embodiments, the first portion and the second portion are equal, each being half of the plurality of optical interconnection expansion cards of the respective computing device. That is, half of the optical interconnection expansion cards of each computing device are connected via optical fibers to half of the optical interconnection expansion cards of an adjacent computing device on one side, and the other half of the optical interconnection expansion cards are connected via optical fibers to half of the optical interconnection expansion cards of an adjacent computing device on the other side, thereby forming a one-dimensional (1D) ring structure.

In some implementations, the topology of the plurality of computing devices can be reconfigured by controlling the first optical switching units and/or the on-chip optical switches. In some embodiments, by controlling the first optical switching units and/or the on-chip optical switches, the topology of the plurality of computing devices can be reconfigured into: a one-dimensional ring structure; or a plurality of independent ring structures, each independent ring structure including the same or a different number of computing devices.

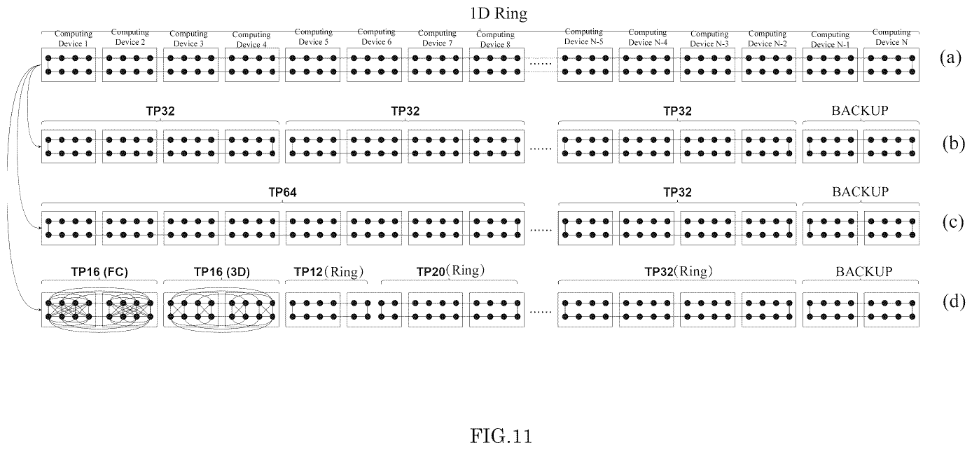

In some embodiments, each computing device includes a plurality of computing modules. The plurality of computing modules of each computing device are connected to a corresponding plurality of optical interconnection expansion cards via metal traces. The topology of the plurality of computing modules in the computing system can be reconfigured by controlling the first optical switching units and/or the on-chip optical switches on the optical interconnection expansion cards. As shown in FIG. 11 (a), the plurality of computing modules in N computing devices form a 1D ring topology. Taking a computing device including 8 computing modules as an example, for computing device 1, by controlling the first optical switching units, half of the links of computing modules OAM6 and OAM7 are used for communication with corresponding computing modules OAM6 and OAM7 in computing device 2; by controlling the first optical switching units and/or the on-chip optical switches, the other half of the links of computing modules OAM6, OAM7 are used for communication with adjacent computing modules in computing device 1. For the remaining computing modules in computing device 1, half of their links are used for communication with two adjacent computing modules. For the 8 computing modules in computing device N, by controlling the first optical switching units, half of the links of computing modules OAM0 and OAM1 are used for communication with corresponding computing modules OAM0 and OAM1 in computing device N−1; by controlling the first optical switching units and/or the on-chip optical switches, the other half of the links of computing modules OAM0, OAM1 are used for communication with adjacent computing modules in computing device N; by controlling the first optical switching units and/or the on-chip optical switches, half of the links of the remaining computing modules in computing device N are used for communication with two adjacent computing modules. For the remaining computing devices M (any one of computing devices 2 to N−1), by controlling the first optical switching units, half of the links of computing modules OAM6, OAM7 are used for communication with corresponding computing modules OAM6, OAM7 in computing device M+1, and the other half of the links of computing modules OAM6, OAM7 are used for communication with adjacent computing modules in computing device M; by controlling the first optical switching units, half of the links of computing modules OAM0, OAM1 are used for communication with corresponding computing modules OAM0, OAM1 in computing device M-1, and the other half of the links of computing modules OAM0, OAM1 are used for communication with adjacent computing modules in computing device M; half of the links of computing modules OAM2, OAM3, OAM4, OAM5 are used for communication with two adjacent computing modules.

By controlling the first optical switching units and/or the on-chip optical switches on the optical interconnection expansion cards, without changing the physical connections of the optical fibers, the topology of the plurality of computing modules can be reconfigured into a plurality of independent ring topologies, as shown in FIG. 11(b). Each independent ring includes 32 computing modules and can form a supernode, e.g., TP32. The computing system also includes a backup node. In this embodiment, any four adjacent computing devices form a supernode. For example, computing devices 1-4 form a first supernode, computing devices 5-8 form a second supernode, and so on. Alternatively, computing devices 1-4 could form a first supernode, computing devices 6-9 form a second supernode, with device 5 as a backup supernode. Any other combination of four adjacent computing devices can form a supernode. In each supernode, taking the first supernode formed by computing devices 1-4 and the second supernode formed by computing devices 5-8 as an example, for the 8 computing modules in computing device 1, by controlling the first optical switching units, half of the links of computing modules OAM6, OAM7 are used for communication with computing modules OAM6, OAM7 in computing device 2 respectively; by controlling the first optical switching units and/or the on-chip optical switches, the other half of the links of computing modules OAM6, OAM7 are used for communication with adjacent computing modules in computing device 1; by controlling the first optical switching units and/or the on-chip optical switches, half of the links of the remaining computing modules in computing device 1 are used for communication with two adjacent computing modules. For the 8 computing modules in computing device 4, by controlling the first optical switching units, half of the links of computing modules OAM0 OAM1 are used for communication with computing modules OAM0, OAM1 in computing device 3 respectively; by controlling the first optical switching units and/or the on-chip optical switch, the other half of the links of computing modules OAM0, OAM1 are used for communication with adjacent computing modules in computing device 4; by controlling the first optical switching units and/or the on-chip optical switches, half of the links of the remaining computing modules in computing device 4 are used for communication with two adjacent computing modules. The communication mode for computing devices 2 and 3 is the same as in the 1D ring topology of the previous embodiment. In this topology, by controlling the first optical switching units in computing devices 4 and 5, the optical fibers connecting the two computing devices are prevented from communicating, thus placing computing devices 4 and 5 in different supernodes.

In alternative implementations, different independent ring topologies include different numbers of computing modules. As shown in FIG. 11(c), the computing system may include a supernode TP64 having 64 computing modules arranged in a ring topology and a supernode TP32 having 32 computing modules arranged in a ring topology. The communication mode is similar to that described above, except that the positions at which optical fiber communication between adjacent computing devices is disabled are different.

In some implementations, by controlling the first optical switching units and/or the on-chip optical switches, the topology of the plurality of computing modules can be reconfigured to include a plurality of supernodes, as shown in FIG. 11(d). The plurality of supernodes include TP16, TP12, TP20, TP32, and a backup node, etc. The plurality of supernodes include a first supernode, e.g., TP16 (FC), wherein a plurality of computing modules are interconnected to form a first-level computing module group, and at least two first-level computing module groups are interconnected to form a second-level computing module group. Furthermore, the plurality of supernodes include a second supernode, e.g., TP16 (3D), wherein the second supernode includes a third-level computing module group formed by interconnecting at least two second-level computing module groups, the second-level computing module group is formed by interconnecting at least two first-level computing module groups, and the first-level computing module group is formed by interconnecting a plurality of computing modules. Further, the plurality of supernodes include a third supernode, e.g., TP12, TP20, TP32, etc., which includes a plurality of computing modules arranged in a one-dimensional ring topology. In this embodiment, the first supernode TP16(FC) includes computing device 1 and computing device 2. By controlling the first optical switching units and/or the on-chip optical switches, the eight computing modules within computing device 1 and computing device 2 form a fully connected pair-wise communication, and corresponding computing modules of computing device 1 and computing device 2 communicate with each other via optical fibers (e.g., computing module OAM1 of computing device 1 and computing module OAM1 of computing device 2 communicate directly via optical fiber). The second supernode TP16(3D) includes computing device 3 and computing device 4. By controlling the first optical switching units and/or the on-chip optical switches, the eight computing modules inside computing device 3 and computing device 4 are divided into two groups of four computing modules. Each group forms a first-level computing module group with a fully connected structure via the on-chip optical switch. Corresponding computing modules between a first-level computing module group and the other first-level computing module group within the same computing device communicate with each other to form a second-level computing module group. Corresponding computing modules between the two second-level computing module groups communicate with each other via optical fibers to form a third-level computing module group. The third supernode, e.g., TP12, comprises eight computing modules from computing device 5 and four computing modules from computing device 6 (e.g., computing modules OAM4-OAM7). In this topology, for computing device 5, by controlling the first optical switching units, half of the links of computing modules OAM6, OAM7 are used for communication with computing modules OAM6, OAM7 in computing device 6 respectively; by controlling the first optical switching units and/or the on-chip optical switches, the other half of the links of computing modules OAM6, OAM7 are used for communication with adjacent computing modules in computing device 5; by controlling the first optical switching units and/or the on-chip optical switch, half of the links of the remaining computing modules in computing device 5 are used for communication with two adjacent computing modules. For computing device 6, by controlling the first optical switching units, half of the links of computing modules OAM6, OAM7 are used for communication with computing modules OAM6, OAM7 in computing device 5 respectively; by controlling the first optical switching units and/or the on-chip optical switches, the other half of the links of computing modules OAM6, OAM7 are used for communication with computing modules OAM4, OAM5 in computing device 6; by controlling the first optical switching units and/or the on-chip optical switches, the other half of the links of computing modules OAM4, OAM5 in computing device 6 are connected to allow communication. Furthermore, the remaining computing modules in computing device 6 are used for supernodes with other topologies.

As shown in FIG. 11(a)-(c), changing the topology between different implementations does not require manual reconnection of optical fibers. Topology reconfiguration is achieved by controlling the first optical switching units and/or the on-chip optical switches to switch link conduction, which is convenient and fast, enabling millisecond-level topology switching latency. Controlling the first optical switching units and/or the on-chip optical switches to enable mutual communication among computing modules within the same computing device includes: controlling the first optical switching unit of an output computing module to transmit the optical signal to the on-chip optical switch (the link to the optical coupling interface connected to the optical fiber is disconnected), and selecting a transmission path within the on-chip optical switch to route the optical signal to a detector of a target computing module. Controlling the first optical switching units to enable communication between computing modules in different computing devices includes: controlling the first optical switching unit to transmit the optical signal to the optical coupling interface connected to the optical fiber (the link to the on-chip optical switch is disconnected), and transmitting the optical signal via the optical fiber to the detector of the target computing module in another computing device.

Furthermore, an embodiment provides a computing system, which includes a plurality of computing devices. Each computing devices comprises a plurality of computing modules and a plurality of optical interconnection expansion cards. Each of the optical interconnection expansion cards includes an on-chip optical switch and at least one first optical switching unit. The optical interconnection expansion cards communicate via optical fiber connections. At least one computing device serves as a backup device, and the remaining computing devices serve as working devices. When one or more working devices malfunction, the connection topology of the plurality of computing devices is reconfigured by controlling the first optical switching units and/or the on-chip optical switches, so that the backup devices equal in number to the malfunctioning working devices become working devices operating normally.

In some embodiments, the plurality of computing devices include N computing devices, where N is an integer greater than 1. The plurality of computing devices are ordered from 1 to N. A first portion of the plurality of optical interconnection expansion cards of computing device M is connected via optical fibers to a portion of the plurality of optical interconnection expansion cards of computing device M−1, and a second portion of the plurality of optical interconnection expansion cards of computing device M is connected via optical fibers to a portion of the plurality of optical interconnection expansion cards of computing device M+1, where M is an integer greater than 1 and less than N. A first portion of the plurality of optical interconnection expansion cards of computing device N is connected via optical fibers to a portion of the plurality of optical interconnection expansion cards of computing device N−1, and a second portion of the plurality of optical interconnection expansion cards of computing device N is connected via optical fibers to a portion of the plurality of optical interconnection expansion cards of computing device 1. A first portion of the plurality of optical interconnection expansion cards of computing device 1 is connected via optical fibers to a portion of the plurality of optical interconnection expansion cards of computing device N, and a second portion of the plurality of optical interconnection expansion cards of computing device 1 is connected via optical fibers to a portion of the plurality of optical interconnection expansion cards of computing device 2. The first portion and the second portion are equal, each being half of the plurality of optical interconnection expansion cards of the respective computing device.

In some embodiments, by controlling the first optical switching units and/or the on-chip optical switches, the computing modules in computing devices 1 to K form a supernode having a predetermined topology, where K is an integer less than N.

In some implementations, when any computing device J among computing devices 1 to K malfunctions, the connection topology of the plurality of computing devices is reconfigured by controlling the on-chip optical switches and/or the first optical switching units in the computing system, so that the backup device joins the connection topology and becomes a working device operating normally, thereby allowing the computing modules in any consecutive computing devices other than computing device J to form a new supernode. In some embodiments, after repair, by controlling the first optical switching units and/or the on-chip optical switches, the repaired computing device J is reconfigured to serve as a backup device.

In some embodiments, controlling the first optical switching units and/or the on-chip optical switches includes: controlling the first optical switching unit to selectively transmit a signal from a computing module to the on-chip optical switch or to the optical fiber; controlling the on-chip optical switch to select a transmission path for communication among computing modules within the same computing device.

In some embodiments, by controlling the first optical switching units and/or the on-chip optical switches, communication links of computing modules in computing devices 1 to N−1 form a one-dimensional ring topology, with computing device N serving as a backup device.

In some implementations, when any computing device M among computing devices 1 to N−1 malfunctions, the connection topology of the plurality of computing devices is reconfigured by controlling the on-chip optical switches and/or the first optical switching units, so that computing device N joins the connection topology and becomes a working device operating normally, and the computing modules in computing devices 1 to M−1 and computing devices M+1 to N are reorganized to form a new one-dimensional ring topology. In some implementations, after repair, by controlling the first optical switching units and/or the on-chip optical switches, the repaired computing device M is reconfigured to serve as a backup device.

In some implementations, changing the connection topology of the plurality of computing devices includes: changing the on-chip optical switches and/or first optical switching units of computing device M-1, computing device M, and computing device M+1 to disconnect optical fiber communication between computing device −1 and computing device M, and between computing device M and computing device M+1, and to adjust communication links of computing modules in computing device M−1 and computing device M+1; and changing the on-chip optical switches and/or the first optical switching units of computing device 1 and computing device N to establish optical fiber communication between computing device 1 and computing device N, and to adjust communication links of computing modules in computing device 1 and computing device N.

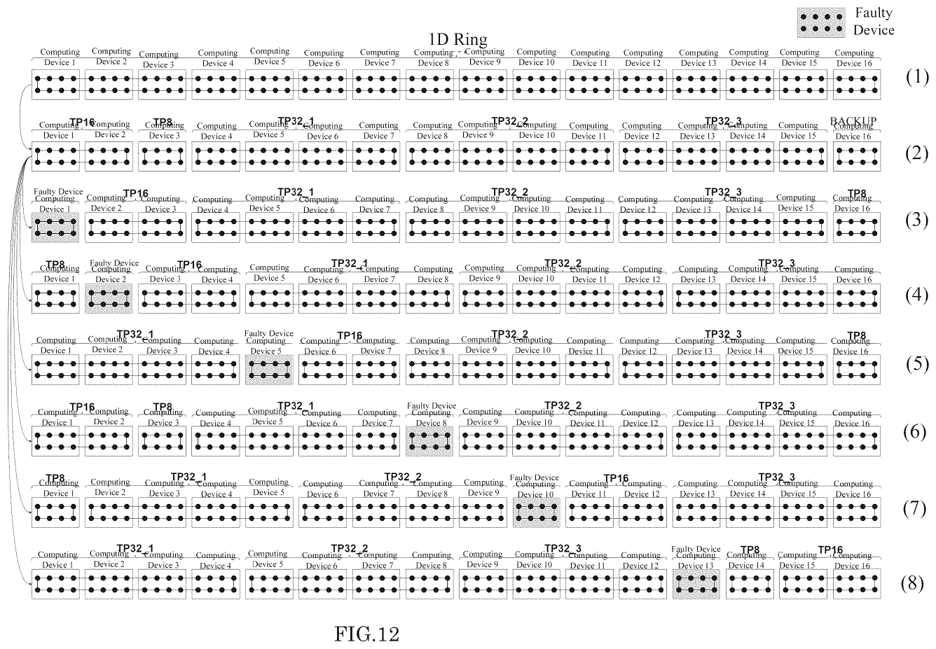

As shown in FIG. 12, in an exemplary embodiment, 16 computing devices are connected via the optical interconnection expansion cards and optical fibers to form a computing system. The connection topology of the 16 computing devices may be reconfigured by controlling the on-chip optical switches and/or the first optical switching units in the computing system. As shown in FIG. 12 (1), the computing devices are sequentially numbered from 1 to 16 and form a one-dimensional (1D) ring topology. By controlling the on-chip optical switches and/or the first optical switching units in the computing system, the connection topology can be reconfigured to include a plurality of independent rings (each serving as a supernode) and a backup node. Specifically, as shown in FIG. 12 (2), computing devices 1 to 15 serve as working devices and are configured to form a plurality of independent supernodes, with computing device 16 serving as a backup device. The plurality of independent supernodes include a first supernode (e.g., a supernode containing 16 computing modules) TP16, a second supernode (e.g., a supernode containing 8 computing modules) TP8, and three third supernodes (e.g., each supernode containing 32 computing modules) including a first third supernode TP32_1, a second third supernode TP32_2, a third third supernode TP32_3. The first supernode TP16 includes computing device 1 and computing device 2. The second supernode TP8 includes computing device 3. The first third supernode TP32_1 includes computing devices 4 to 7, the second third supernode TP32_2 includes computing devices 8 to 11, and the third third supernode TP32_3 includes computing devices 12 to 15. Computing device 16 serves as a backup device.

In some embodiments, as shown in FIG. 12(3), if computing device 1 malfunctions, the connection topology is reconfigured by controlling the on-chip optical switches and/or the first optical switching units in the computing system, such that the first supernode TP16 includes computing device 2 and computing device 3, the second supernode TP8 includes computing device (original backup device) 16, and the three third supernodes TP32_1, TP32_2, TP32_3 remain unreconfigured. In other words, after computing device 1 of the first supernode TP16 malfunctions, the backup device becomes the new second supernode TP8, computing device 3 and computing device 2 are reorganized to form a new first supernode TP16, and the connections of other computing devices remain unchanged. After computing device 1 is repaired, it can serve as a new backup device.

In some embodiments, as shown in FIG. 12 (4), if computing device 2 malfunctions, the connection topology is reconfigured by controlling the on-chip optical switches and/or the first optical switching units in the computing system, such that the first supernode TP16 includes computing device 3 and computing device 4, the second supernode TP8 includes computing device 1, the first third supernode TP32_1 includes computing devices 5 to 8, the second third supernode TP32_2 includes computing devices 9 to 12, and the third third supernode TP32_3 includes computing devices 13 to 16. That is, when computing device 2 malfunctions, computing device 1 of the original first supernode TP16 is replaced as the second supernode TP8, and the new first supernode TP16 and the three third supernodes are shifted forward by one device. After computing device 2 is repaired, it can serve as a new backup device.

In some implementations, as shown in FIG. 12(5), if computing device 5 malfunctions, the connection topology is reconfigured by controlling the on-chip optical switches and/or the first optical switching units in the computing system, such that the first supernode TP16 includes computing device 6 and computing device 7, the second supernode TP8 includes computing device 16, the first third supernode TP32_1 includes computing devices 1 to 4, and the second third supernode TP32_2 and third third supernode TP32_3 remain unchanged. That is, when computing device 5 malfunctions, the backup device replaces it as the second supernode TP8, and the third supernodes TP32_1, TP32_2, and the first supernode TP16 form a new topology according to the device numbers shown in FIG. 12 (5), while others remain unchanged. After computing device 5 is repaired, it can serve as a new backup device.

In some implementations, as shown in FIG. 12(6), if computing device 8 malfunctions, the connection topology is reconfigured by controlling the on-chip optical switches and/or the first optical switching units in the computing system, such that the first supernode TP16, the second supernode TP8, and the first third supernode TP32_1 remain unchanged, the second third supernode TP32_2 includes computing devices 9 to 12, and the third third supernode TP32_3 includes computing devices 13 to 16. That is, when computing device 8 malfunctions, the third supernodes TP32_2 and TP32_3 form a new topology according to the device numbers shown in FIG. 12 (6), while others remain unchanged. After computing device 8 is repaired, it can serve as a new backup device.

In some implementations, as shown in FIG. 12(7), if computing device 10 malfunctions, the connection topology is reconfigured by controlling the on-chip optical switches and/or the first optical switching units in the computing system, such that the first supernode TP16 includes computing device 11 and computing device 12, the second supernode TP8 includes computing device 1, the first third supernode TP32_1 includes computing devices 2 to 5, the second third supernode TP32_2 includes computing devices 6 to 9, and the third third supernode TP32_3 includes computing devices 13 to 16. Accordingly, when computing device 10 malfunctions, all 16 servers form a new topology according to the device numbers shown in FIG. 12 (7). After computing device 10 is repaired, it can serve as a new backup device.

In some implementations, as shown in FIG. 12(8), if computing device 13 malfunctions, the connection topology is reconfigured by controlling the on-chip optical switches and/or the first optical switching units in the computing system, such that the first supernode TP16 includes computing device 15 and computing device 16, the second supernode TP8 includes computing device 14, the first third supernode TP32_1 includes computing devices 1 to 4, the second third supernode TP32_2 includes computing devices 5 to 8, and the third third supernode TP32_3 includes computing devices 9 to 12. That is, when computing device 13 malfunctions, all 16 servers form a new topology according to the device numbers shown in FIG. 12(8). After computing device 13 is repaired, it can serve as a new backup device.

As described above, when a single computing device (which may be a server) malfunctions and needs replacement, the system automatically reconfigures the connection topology among the supernodes in real time by controlling the on-chip optical switches and/or the first optical switching units. Any consecutive working devices may thereby form new supernodes, improving overall operational efficiency.

In some embodiments, the connection topology of the plurality of computing devices is reconfigured by controlling the on-chip optical switches and/or the first optical switching units in the computing system, such that a portion of the computing devices operate as working devices forming a plurality of independent supernodes, and the remaining computing devices operate as backup devices. The plurality of independent supernodes include one or more first supernodes and one or more second supernodes. Each first supernode includes one or more computing devices, and each second supernode includes one or more computing devices. The topological structure of the first supernode is different from the topological structure of the second supernode. In some embodiments, if any working device malfunctions, the connection topology of the plurality of computing devices is reconfigured by controlling the on-chip optical switches and/or the first optical switching units in the computing system, so that the malfunctioning computing device is communicatively isolated, the backup devices equal in number to the malfunctioning working devices are activated as working devices, and any consecutive working devices are reorganized to form the first supernodes and the second supernodes.

In some embodiments, the plurality of independent supernodes further include one or more third supernodes, each third supernode including one or more computing devices. The topological structure of the third supernode is different from the topological structures of the first supernode and the second supernode. In some embodiments, if any working device malfunctions, the connection topology of the plurality of computing devices is reconfigured by controlling the on-chip optical switches and/or the first optical switching units in the computing system, so that the malfunctioning computing device is communicatively isolated, the backup devices equal in number to malfunctioning working devices are activated to become new working devices, and any consecutive working devices are reorganized to form the first supernodes, the second supernodes, and the third supernodes. In some embodiments, the topological structures of the first supernode, the second supernode, and the third supernode are one-dimensional ring topologies with different numbers of computing modules.

Furthermore, in some embodiments, each computing device includes a plurality of computing modules. The plurality of computing modules of each computing device are connected to a plurality of optical interconnection expansion cards via metal traces. Each optical interconnection expansion card comprises an on-chip optical switch and at least one first optical switching unit. The optical interconnection expansion cards of the plurality of computing devices communicate via optical fiber connections. At least a portion of the computing modules of at least one computing device serve as backup modules, and the remaining computing modules are working modules. When one or more working modules malfunction, the connection topology of the plurality of working modules is reconfigured by controlling the first optical switching units and/or the on-chip optical switches, so that the backup modules equal in number to the malfunctioning working modules become working modules.

In some embodiments, the plurality of computing devices include N computing devices, where N is an integer greater than 1. The plurality of computing devices are ordered from 1 to N. For any computing device M, where M is an integer greater than 1 and less than N, a first portion of the plurality of optical interconnection expansion cards of computing device M is connected via optical fibers to a portion of the plurality of optical interconnection expansion cards of computing device M−1, and a second portion of the plurality of optical interconnection expansion cards of computing device M is connected via optical fibers to a portion of the plurality of optical interconnection expansion cards of computing device M+1. A first portion of the plurality of optical interconnection expansion cards of computing device N is interconnected via optical fibers to a portion of the plurality of optical interconnection expansion cards of computing device N-1, and a second portion of the plurality of optical interconnection expansion cards of computing device N is interconnected via optical fibers to a portion of the plurality of optical interconnection expansion cards of computing device 1. A first portion of the plurality of optical interconnection expansion cards of computing device 1 is connected via optical fibers to a portion of the plurality of optical interconnection expansion cards of computing device N, and a second portion of the plurality of optical interconnection expansion cards of computing device 1 is connected via optical fibers to a portion of the plurality of optical interconnection expansion cards of computing device 2. In some embodiments, the first portion and the second portion are equal, each being half of the plurality of optical interconnection expansion cards of the respective computing device.

In some embodiments, the connection topology of the plurality of computing modules in the computing system is reconfigured by controlling the on-chip optical switches and/or the first optical switching units, such that a portion of the plurality of computing modules operate as working modules and form one or more independent supernodes, and the remaining computing modules serve as backup modules. The one or more independent supernodes include one or more first supernodes. Each first supernode includes a plurality of consecutive computing modules. By controlling the on-chip optical switches and/or the first optical switching units, the plurality of computing modules within the first supernode form a first target topological structure. In some embodiments, the one or more independent supernodes include one or more second supernodes. Each second supernode includes a plurality of consecutive computing modules. By controlling the on-chip optical switches and/or the first optical switching units, the plurality of computing modules within the second supernode form a second target topological structure. The first target topological structure is different from the second target topological structure. In some embodiments, the plurality of independent supernodes further include one or more third supernodes. Each third supernode includes a plurality of consecutive computing modules. By controlling the on-chip optical switches and/or the first optical switching units, the plurality of computing modules within the third supernode form a third target topological structure. The third target topological structure is different from the first target topological structure and the second target topological structure. In some embodiments, if any working module malfunctions, the connection topology of the plurality of computing modules is reconfigured by controlling the on-chip optical switches and the first optical switching units, so that the malfunctioning computing module is communicatively isolated, the backup modules equal in number to the malfunctioning working modules are activated to become new working modules, and any consecutive working modules are reorganized to form a plurality of new supernodes having the same topological structures.

In some embodiments, the first target topological structure, the second target topological structure, and the third target topological structure are one-dimensional ring topological structures with different numbers of computing modules.

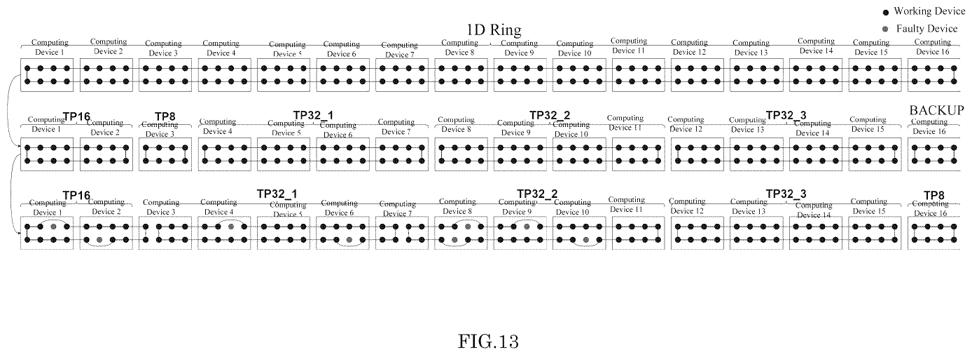

As shown in FIG. 13, taking 16 interconnected computing devices as an example, reconfigurable topologies are built using reconfigurable optical interconnection modules. As shown, the system comprises three TP32 supernodes, one TP16 supernode, one TP8 supernode, and one backup device. When one or more computing modules within the system malfunction, the system automatically switches the communication links among computing modules in real-time via the on-chip optical switches and/or the first optical switching units to isolate the faulty modules, and to activate backup modules from the backup device to join the connection topology to replace the faulty modules. This can improve the overall operational efficiency of the AI computing system.

In some embodiments, the backup modules are not limited to being located within one backup device, but can be distributed at various positions adjacent to the one or more supernodes.

Those skilled in the art will appreciate that the above disclosure is merely embodiments of the present invention and, of course, should not be used to limit the scope of the patent protection sought by the present invention. Equivalent changes made according to the embodiments of the present invention still fall within the scope of the claims.

Furthermore, the technical solutions described above may further be expressed as follows.

### Embodiment 1

A photonic integrated circuit (PIC) chip comprising one or more photonic integrated circuit sub-modules, each sub-module comprising:
a plurality of first optical switching units, each first optical switching unit comprising a first optical input port, a first optical output port, and a second optical output port, and being configured to selectively output an optical signal received at the first optical input port via either the first optical output port or the second optical output port;
at least one on-chip optical switch having a plurality of optical input ports and a plurality of optical output ports, the plurality of optical input ports being respectively optically connected to the second optical output ports of the plurality of first optical switching units, the at least one on-chip optical switch being configured to selectively output an optical signal received at any one of the plurality of optical input ports via at least one of the plurality of optical output ports;
a plurality of modulators optically connected to corresponding first optical input ports of the plurality of first optical switching units and configured to modulate information carried by an electrical signal onto the optical signal;
a plurality of detectors, at least a portion of the plurality of detectors being optically connected to the plurality of optical output ports of the at least one on-chip optical switch;

a plurality of first optical couplers configured to optically connect the first optical output ports of the plurality of first optical switching units to a first external optical fiber array; and
a second optical coupler optically connected to at least a portion of the plurality of detectors and configured to transmit optical signals from a second external optical fiber array to the portion of the plurality of detectors.

### Embodiment 2

The PIC chip according to Embodiment 1, wherein each photonic integrated circuit sub-module further comprises a plurality of wavelength multiplexers and a plurality of demultiplexers;
wherein the plurality of modulators are configured as a plurality of modulator arrays, and the detectors are configured as a plurality of detector arrays;
wherein each modulator array is optically connected to a corresponding first optical switching unit via a respective wavelength multiplexer in the plurality of wavelength multiplexers, wherein each wavelength multiplexer comprises a plurality of optical input ports and one optical output port, each of the plurality of optical input ports being connected to a respective modulator in the modulator array, and the optical output port being connected to the first optical input port of a corresponding first optical switching unit; and
wherein the detector array is optically connected to a corresponding optical output port of the at least one on-chip optical switch or to the second optical coupler via a respective demultiplexer in the plurality of demultiplexers, wherein each demultiplexer comprises one optical input port and a plurality of optical output ports, the optical input port being connected to on optical output port of the at least one on-chip optical switch or to the second optical coupler, and each of the plurality of optical output ports being connected to a respective detector in the detector array.

### Embodiment 3

The PIC chip according to Embodiment 1 or 2, wherein a number of detectors or detector arrays is twice a number of modulators or modulator arrays, and wherein a portion of the detectors or detector arrays is connected to the at least one on-chip optical switch, and another portion is connected to the second optical coupler.

### Embodiment 4

The PIC chip according to Embodiment 1 or 2, wherein each photonic integrated circuit sub-module further comprises a third optical switching unit, the detectors or demultiplexers are optically connected to the at least one on-chip optical switch and the second optical coupler via the third optical switching unit, and a number of detectors or detector arrays is equal to a number of modulators or modulator arrays.

### Embodiment 5

The PIC chip according to Embodiment 4, wherein the third optical switching unit comprises a first optical input port, a second optical input port, and an optical output port;
wherein the first optical input port of the third optical switching unit is connected to the second optical coupler, the second optical input port of the third optical switching unit is connected to one optical output port of the at least one on-chip optical switch, the optical output port of the third optical switching unit is connected to a respective detector or demultiplexer, and
wherein the third optical switching unit is configured to selectively establish optical communication between its first optical input port and its optical output port or between its second optical input port and its optical output port.

### Embodiment 6

The PIC chip according to Embodiment 4, wherein the third optical switching unit is respectively disposed on an optical path between the detector or detector array and the at least one on-chip optical switch and on an optical path between the detector or detector array and the second optical coupler.

### Embodiment 7

The PIC chip according to Embodiment 4, wherein the third optical switching unit comprises a MEMS optical circuit switching unit or a Mach-Zehnder interferometer (MZI) optical circuit switching unit.

### Embodiment 8

The PIC chip according to Embodiment 1 or 2, wherein the at least one on-chip optical switch comprises a plurality of second optical switching units configured to select transmission paths of optical signals input to the at least one on-chip optical switch such that the optical signals are output from at least one optical output port of the at least one on-chip optical switch.

### Embodiment 9

The PIC chip according to Embodiment 8, wherein each first optical switching unit comprises a MEMS optical circuit switching unit or an MZI optical circuit switching unit; and/or
the second optical switching unit comprises an MZI optical circuit switching unit.

### Embodiment 10

The PIC chip according to Embodiment 9, wherein each first optical switching unit comprises an MZI optical circuit switching unit including:
a first beam splitter having one optical input port and two optical output ports;
a second beam splitter having two optical input ports and two optical output ports; and
two phase shifters respectively connected between the two optical output ports of the first beam splitter and the two optical input ports of the second beam splitter.

### Embodiment 11

The PIC chip according to Embodiment 8, wherein each second optical switching unit comprises:
two beam splitters each having two optical input ports and two optical output ports, the two beam splitters including a first beam splitter and a second beam splitter;
two phase shifters respectively connected between the two optical output ports of the first beam splitter and the two optical input ports of the second beam splitter.

### Embodiment 12

The PIC chip according to Embodiment 1 or 2, wherein each modulator comprises at least one of: a microring modulator, a Mach-Zehnder modulator, and an electro-absorption modulator;
and/or, each detector comprises a microring detector or a photodiode.

### Embodiment 13

The PIC chip according to Embodiment 1 or 2, wherein each photonic integrated circuit sub-module further comprises:
a third optical coupler configured to receive light from an off-chip light source;
an optical power splitter optically connected to the third optical coupler and configured to split input light into a plurality of output lights having substantially equal power, the plurality of output lights being transmitted to respective modulators.

### Embodiment 14

An optical interconnection module comprising the PIC chip according to any one of Embodiments 1 to 13 and a transceiver analog electrical chip;
wherein the transceiver analog electrical chip is configured to convert a received first digital electrical signal into a driving analog electrical signal carrying information and transmit the driving analog electrical signal to at least one modulator in the PIC chip, or to receive an analog electrical signal output from at least one detector in the PIC chip and convert the analog electrical signal into a second digital electrical signal; and wherein the modulator is configured to modulate the information carried by the driving analog electrical signal onto the optical signal.

### Embodiment 15

The optical interconnection module according to Embodiment 14, wherein the transceiver analog electrical chip is disposed above the PIC chip and configured to receive the first digital electrical signal and/or to transmit the second digital electrical signal through conductive vias extending through the PIC chip.

### Embodiment 16

The optical interconnection module according to Embodiment 14, further comprising an optical switching control analog electrical chip corresponding to the on-chip optical switch in the PIC chip and configured to control the plurality of second optical switching units to select a transmission path for an optical signal received by the on-chip optical switch such that the optical signal is output from a predetermined optical output port.

### Embodiment 17

The optical interconnection module according to Embodiment 16, wherein the optical switching control analog electrical chip is disposed above the PIC chip and configured to receive an optical switching control analog signal through conductive vias extending through the PIC chip.

### Embodiment 18

The optical interconnection module according to Embodiment 14, further comprising a substrate, the PIC chip being mounted on the substrate, and the transceiver analog electrical chip being mounted on a side of the PIC chip opposite the substrate.

### Embodiment 19

An optical interconnection expansion card comprising:
a first printed circuit board (PCB);
the optical interconnection module according to any one of Embodiments 14 to 18 disposed on the first PCB;
a plurality of optical fiber interfaces disposed on the first PCB and optically connected to the optical interconnection module via the first external optical fiber array and the second external optical fiber array to implement optical communication with the optical interconnection module;
a plurality of electrical communication interfaces disposed on the first PCB and configured to receive the first digital electrical signals and/or transmit the second digital electrical signals; and;
a plurality of retimers disposed on the first PCB and communicatively connected to the plurality of electrical communication interfaces and the optical interconnection module, the plurality of retimers being configured to retime the first digital electrical signals and transmit retimed electrical signals to the optical interconnection module and/or to retime the second digital electrical signals received from the optical interconnection module and transmit the retimed signals through the plurality of electrical communication interfaces.

### Embodiment 20

The optical interconnection expansion card according to Embodiment 19, wherein each retimer has a plurality of communication channels,
the plurality of electrical communication interfaces have a plurality of communication channels, and
a total number of communication channels of the plurality of retimers is equal to a total number of electrical communication channels of the plurality of electrical communication interfaces.

### Embodiment 21

The optical interconnection expansion card according to Embodiment 19, wherein the plurality of retimers are communicatively connected to the optical interconnection module via PCB traces on the first PCB.

### Embodiment 22

The optical interconnection expansion card according to Embodiment 19, further comprising a laser module disposed on the first PCB and optically connected to the optical interconnection module via a third optical fiber array to transmit a laser beam to the optical interconnection module.

### Embodiment 23

A computing device, comprising:
a plurality of computing modules; and
a plurality of optical interconnection expansion cards according to any one of Embodiments 19 to 22;
wherein the plurality of computing modules are communicatively connected to the plurality of optical interconnection expansion cards.

### Embodiment 24

The computing device according to Embodiment 23, further comprising a second printed circuit board (PCB),
wherein the plurality of computing modules are disposed on the second PCB,
the plurality of optical interconnection expansion cards are plugged into the second PCB, and
the plurality of computing modules are communicatively connected to the plurality of optical interconnection expansion cards via PCB traces on the second PCB.

### Embodiment 25

A computing system, comprising:
a plurality of computing devices according to Embodiment 23 or 24;
at least one switch;
wherein the plurality of optical interconnection expansion cards of the plurality of computing devices are communicatively connected to the at least one switch through optical fibers so as to communicatively connect the plurality of computing devices.

### Embodiment 26:

The computing system according to Embodiment 25, wherein the least one switch comprises an optical circuit switch or an electrical switch including an optical module configured to perform optical communication with the plurality of optical interconnection expansion cards.

1. A computing system, comprising:
a plurality of computing devices, each computing device comprising:
a plurality of computing modules; and
a plurality of optical interconnect expansion cards,
wherein each optical interconnect expansion card comprises at least one on-chip optical switch and at least one first optical switching unit,
wherein the optical interconnect expansion cards of the plurality of computing devices are communicatively connected to one another via optical fibers,
wherein at least one of the plurality of computing devices is configured as a backup device and remaining computing devices are configured as working devices, and
wherein, in response to a malfunction of one or more of the working devices, a connection topology of the plurality of computing devices is reconfigured by controlling the at least one first optical switching unit and/or the at least one on-chip optical switches of the optical interconnect expansion cards, such that the backup devices equal in number to the malfunctioning working devices are switched to operate as working devices.

2. The computing system of claim 1, wherein the plurality of computing devices comprises N computing devices, N being an integer greater than 1,
wherein the computing devices are logically ordered from 1 to N, and
wherein:
for each computing device M, wherein 1<M<N,
a first portion of the optical interconnect expansion cards of computing device M is connected via optical fibers to a portion of the optical interconnect expansion cards of computing device M−1, and
a second portion of the optical interconnect expansion cards of computing device M is connected via optical fibers to a portion of the optical interconnect expansion cards of computing device M+1;
a first portion of the optical interconnect expansion cards of computing device N is connected via optical fibers to a portion of the optical interconnect expansion cards of computing device N−1, and
a second portion of the optical interconnect expansion cards of computing device N is connected via optical fibers to a portion of the optical interconnect expansion cards of computing device 1; and
a first portion of the optical interconnect expansion cards of computing device 1 is connected via optical fibers to a portion of the optical interconnect expansion cards of computing device N, and
a second portion of the optical interconnect expansion cards of computing device 1 is connected via optical fibers to a portion of the optical interconnect expansion cards of computing device 2.

3. The computing system according to claim 2, wherein the first portion and the second portion are equal in number, each comprising half of the optical interconnect expansion cards of the respective computing device.

4. The computing system according to claim 2, wherein, by controlling the at least one first optical switching unit and/or the at least one on-chip optical switches, computing modules in computing devices 1 through K form a supernode having a predetermined topology,
wherein K is an integer less than N.

5. The computing system according to claim 4, wherein, in response to a malfunction of computing device J among computing devices 1 through K, the connection topology is reconfigured by controlling the at least one on-chip optical switches and/or the at least one first optical switching unit such that:
a backup device joins the connection topology and operates as a working device; and
computing modules in consecutive computing devices other than computing device J form a new supernode.

6. The computing system according to claim 5, wherein, after computing device J is repaired, the connection topology is further reconfigured such that computing device J is configured as a backup device by controlling the at least one on-chip optical switches and/or the at least one first optical switching unit.

7. The computing system according to claim 1, wherein controlling the at least one first optical switching unit and/or the at least one on-chip optical switches comprises:
controlling the first optical switching unit to selectively transmit a signal from a computing module to the at least one on-chip optical switch or to an optical fiber; and
controlling the at least one on-chip optical switch to select a transmission path for communication among the plurality of computing modules within the same computing device.

8. The computing system according to claim 2, wherein the connection topology of the plurality of computing devices is reconfigured by controlling the at least one on-chip optical switches and/or the at least one first optical switching unit, such that a subset of the plurality of computing devices operates as working devices and forms a plurality of independent supernodes, and the remaining computing devices operate as backup devices,
wherein the plurality of independent supernodes comprise one or more first supernodes and one or more second supernodes,
wherein each first supernode comprises one or more computing devices,
wherein each second supernode comprises one or more computing devices, and
wherein a topology of the first supernodes differs from a topology of the second supernodes.

9. The computing system according to claim 8, wherein, in response to a malfunction of any computing device operating as a working device, the connection topology is reconfigured by controlling the at least one on-chip optical switches and/or the at least one first optical switching unit, such that:
the malfunctioning computing device is communicatively isolated;
the backup devices equal in number to the malfunctioning computing devices activated as working devices; and
consecutive working devices are reorganized to form the first supernodes and the second supernodes.

10. The computing system according to claim 8,
wherein the plurality of independent supernodes further comprise one or more third supernodes,
wherein each third supernode comprises one or more computing devices, and
wherein a topology of the third supernodes differs from the topologies of the first supernodes and the second supernodes.

11. The computing system according to claim 10, wherein, in response to a malfunction of any computing device operating as a working device, the connection topology is reconfigured by controlling the at least one on-chip optical switches and/or the at least one first optical switching unit, such that:
the malfunctioning computing device is communicatively isolated;
the backup devices equal in number to the malfunctioning computing devices are activated as working devices; and
consecutive working devices are reorganized to form the first supernodes, the second supernodes, and the third supernodes.

12. The computing system according to claim 11, wherein:
each first supernode comprises one computing device,
each second supernode comprises two computing devices, and
each third supernode comprises four computing devices.

13. A computing system, comprising:
a plurality of computing devices, each computing device comprising:
a plurality of computing modules; and
a plurality of optical interconnect expansion cards,
wherein each optical interconnect expansion card comprises an at least one on-chip optical switch and at least one first optical switching unit,
wherein the optical interconnect expansion cards of the plurality of computing devices are communicatively connected via optical fibers,
wherein at least a portion of the computing modules of at least one computing device are configured as backup modules and the remaining computing modules are configured as working modules, and
wherein, in response to a malfunction of one or more working modules, a connection topology of the computing modules is reconfigured by controlling the at least one first optical switching unit and/or the at least one on-chip optical switches such that-the backup modules equal in number to the malfunctioning working modules are switched to operate as working modules.

14. The computing system of claim 13, wherein the plurality of computing devices comprises N computing devices, N being an integer greater than 1,
wherein the computing devices are logically ordered from 1 to N, and
wherein:
for each computing device M, wherein 1<M<N,
a first portion of the optical interconnect expansion cards of computing device M is connected via optical fibers to a portion of the optical interconnect expansion cards of computing device M−1, and
a second portion of the optical interconnect expansion cards of computing device M is connected via optical fibers to a portion of the optical interconnect expansion cards of computing device M+1;
a first portion of the optical interconnect expansion cards of computing device N is connected via optical fibers to a portion of the optical interconnect expansion cards of computing device N−1, and
a second portion of the optical interconnect expansion cards of computing device N is connected via optical fibers to a portion of the optical interconnect expansion cards of computing device 1; and
a first portion of the optical interconnect expansion cards of computing device 1 is connected via optical fibers to a portion of the optical interconnect expansion cards of computing device N, and
a second portion of the optical interconnect expansion cards of computing device 1 is connected via optical fibers to a portion of the optical interconnect expansion cards of computing device 2.

15. The computing system according to claim 14, wherein the first portion and the second portion are equal in number, each comprising half of the optical interconnect expansion cards of the respective computing device.

16. The computing system according to claim 14, wherein the connection topology of the computing modules is reconfigured by controlling the at least one on-chip optical switches and/or the at least one first optical switching unit, such that:
a subset of the computing modules operates as working modules and forms one or more independent supernodes, and
the remaining computing modules operate as backup modules,
wherein the one or more independent supernodes comprise one or more first supernodes,
wherein each first supernode comprises consecutive computing modules, and
wherein the computing modules within each first supernode form a first target topology by controlling the at least one on-chip optical switches and/or the at least one first optical switching unit.

17. The computing system according to claim 16,
wherein the one or more independent supernodes further comprise one or more second supernodes,
wherein each second supernode comprises consecutive computing modules,
wherein the computing modules within each second supernode form a second target topology by controlling the at least one on-chip optical switches and/or the at least one first optical switching unit, and
wherein the first target topology differs from the second target topology.

18. The computing system according to claim 17,
wherein the plurality of independent supernodes further comprise one or more third supernodes,
wherein each third supernode comprises consecutive computing modules,
wherein the computing modules within each third supernode form a third target topology by controlling the at least one on-chip optical switches and/or the at least one first optical switching unit, and
wherein the third target topology differs from the first target topology and the second target topology.

19. The computing system according to claim 18, wherein the first target topology, the second target topology, and the third target topology each comprise a one-dimensional ring topology with different numbers of computing modules.

20. The computing system according to claim 18,
wherein, in response to a malfunction of any working module, the connection topology is reconfigured by controlling the at least one on-chip optical switches and/or the at least one first optical switching unit, such that:
the malfunctioning working module is communicatively isolated;
the backup modules equal in number to the malfunctioning working modules are activated as working modules; and
consecutive working modules are reorganized to form a new plurality of supernodes having the same respective topologies as prior to the malfunction.

21. The computing system according to claim 20, wherein the backup modules are distributed at any position adjacent to the one or more supernodes.
